(19) United States
(12) Patent Application Publication
(10) Pub. No.: US 2022/0051543 A1
(43) Pub. Date: Feb. 17, 2022

(54) Autonomous Monitoring System

(71) Applicant: Viet Nguyen, San Jose, CA (US)

(72) Inventor: Viet Nguyen, San Jose, CA (US)

(21) Appl. No.: 17/404,625

(22) Filed: Aug. 17, 2021

Related U.S. Application Data
(60) Provisional application No. 63/066,613, filed on Aug. 17, 2020.

(51) Int. Cl. G08B 21/18; G08B 25/01; G08B 25/00; G08B 29/18

(52) U.S. Cl. CPC G08B 21/18; G08B 25/01; G06N 20/00; G08B 29/185; G08B 25/009

(57) ABSTRACT

A method facilitates autonomous and continuous monitoring of hazardous conditions such as wildfires, building fires, hurricanes, earthquakes, burglaries, etc. The method detects and assesses multiple parameters associated with hazardous conditions through an autonomous monitoring system (AMS) that comprises multiple autonomous monitoring devices (AMDs) installed in field. Through cameras and sensors, each AMD acquires inputs/measurements in various formats and identifies any hazardous condition thereof. With solar panels installed, each AMD can continuously monitor an environment without being dependent on a power grid. Both the AMS and AMD units use AI technologies in detecting and identifying hazardous conditions. Once a hazardous condition is identified, an AMD sends information to the AMS to verify. If confirmed, the method sends alarms to both emergency responders/authorities and any entity corresponding to the AMD for immediate action. Thus, the method provides efficient and effective monitoring for hazardous conditions to save lives and minimize damages.

The current application claims a priority to the U.S. Provisional Patent application Ser. No. 63/066,613 filed on Aug. 17, 2020.

### FIELD OF THE INVENTION

The present invention relates generally to an autonomous monitoring system and method. More specifically, the present invention relates to an autonomous monitoring system for monitoring hazardous conditions such as fire, earthquake, burglary, wildfire, hurricane, etc.

### BACKGROUND OF THE INVENTION

Natural disasters and hazardous conditions such as wildfires, earthquake, hurricanes, burglaries, etc. are dangerous and difficult to predict. Though these hazardous conditions have early warning signs, the time elapsed between the warning signs and a hazardous condition is short. Additionally, a parameter associated with a warning sign by itself is not a good indicator of a possible disaster. Multiple parameters associated with multiple warning signs must be assessed together to determine the possibility of a disaster such as wildfire. Therefore, there is a need for a monitoring system that can detect and assess multiple parameters associated with hazardous conditions.

As hazardous conditions can happen at any time, there is a need for a monitoring system and method that continuously monitors an environment for any possible signs thereof. The present invention is an autonomous monitoring system and method for monitoring hazardous conditions. The present invention can detect and assess multiple parameters associated with hazardous conditions. Further, the present invention can be powered by solar energy, allowing the present invention to continuously monitor an environment without being dependent on a power grid.

### SUMMARY OF THE INVENTION

The present invention offers a method and system that facilitates autonomous and continuous monitoring of hazardous conditions including, but not limited to wildfires, building fires, hurricanes, earthquakes, burglaries, etc. The online and/or mobile application method of the present invention can detect and assess multiple parameters associated with hazardous conditions through the autonomous monitoring system (AMS) that comprises multiple autonomous monitoring devices (AMDs) installed in various applications and/or locations.

Each AMD includes a post that supports a housing unit and includes a plurality of solar panels for self-powering the AMD. The housing unit is mounted to the post and houses cameras, sensors, rechargeable battery, solar charge controller, wireless communication module, and an artificial intelligence (AI) module. The AMD acquires inputs/measurements in various formats and identifies any hazardous condition thereof. Thus, the AMD can continuously monitor an environment without being dependent on a power grid.

Both AMS and AMD units use AI technologies, including, but not limited to, pattern recognition, machine learning, etc., in detecting and identifying hazardous conditions based on inputs acquired. Once an AMD identifies a hazardous condition, the AMD communicates with and sends all information to the AMS, where the hazardous condition is verified. If the hazardous condition is confirmed, the method sends alarms to both emergency responders/authorities and any entity corresponding to the AMD for immediate action. Further, the method displays the locations of all AMDs that have detected a hazardous condition on a system monitor in a form including, but not limited to map, list, table, etc.

### BRIEF DESCRIPTION OF THE DRAWINGS

FIG. 1 is a system diagram of the method of the present invention.

FIG. 2 is a flowchart of the overall process of the method of the present invention, wherein the method facilitates an autonomous monitoring system (AMS) for hazardous conditions.

FIG. 3 is a flowchart of a sub-process for configuring an autonomous monitoring device (AMD) of the method of the present invention, wherein the AMD is included in the AMS.

FIG. 4 is a flowchart of an alternative embodiment of the sub-process for configuring an AMD of the method of the present invention, wherein the AMD comprises a plurality of solar panels.

FIG. 5 is a flowchart of another embodiment of the sub-process for configuring an AMD of the method of the present invention, wherein the AMD comprises an omnidirectional (360-degree) camera.

FIG. 6 is a flowchart of another embodiment of the sub-process for configuring an AMD of the method of the present invention, wherein the AMD comprises at least one accelerometer sensor.

FIG. 7 is a flowchart of another embodiment of the sub-process for configuring an AMD of the method of the present invention, wherein the AMD comprises a wireless communication module.

FIG. 8 is a flowchart of a sub-process for identifying hazardous conditions through an artificial intelligence (AI) module of the method of the present invention, wherein the AI module comprises a pattern recognition algorithm.

FIG. 9 is a flowchart of an alternative embodiment of the sub-process for identifying hazardous conditions through an AI module of the method of the present invention, wherein the AI module comprises at least one database.

FIG. 10 is a flowchart of another embodiment of the sub-process for identifying hazardous conditions through an AI module of the method of the present invention, wherein the AI module comprises a machine learning algorithm.

FIG. 11 is a flowchart of a sub-process for displaying AMDs with hazardous conditions of the method of the present invention.

FIG. 12 is a system diagram of an alternative embodiment of the method of the present invention, wherein the method facilitates the AMS through an online platform and/or mobile application.

FIG. 13 is a flowchart of the overall process of the alternative embodiment of the method of the present invention.

FIG. 14 is a perspective view of the AMD of the present invention.

FIG. 15 is a front-side view of the AMD of the present invention.

FIG. 16 is a right-side view of the AMD of the present invention.

FIG. 17 is a top-side view of the AMD of the present invention.

FIG. 18 is an electrical diagram of the AMD of the present invention.

### DETAIL DESCRIPTIONS OF THE INVENTION

All illustrations of the drawings are for the purpose of describing selected versions of the present invention and are not intended to limit the scope of the present invention.

The present invention comprises a method and system for autonomously and continuously monitoring hazardous conditions including, but not limited to wildfires, building fires, hurricanes, earthquakes, burglaries, etc. The autonomous monitoring system (AMS) and method of the present invention can detect and assess multiple parameters associated with hazardous conditions using an autonomous monitoring device (AMD) installed for any applications. Both AMS and AMD units use artificial intelligence (AI) technologies in detecting and identifying hazardous conditions based on inputs from cameras and/or sensors installed on the AMD units. Further, each AMD of the present invention comprises solar panels, thus can be powered by solar energy, allowing the present invention to continuously monitor an environment without being dependent on a power grid.

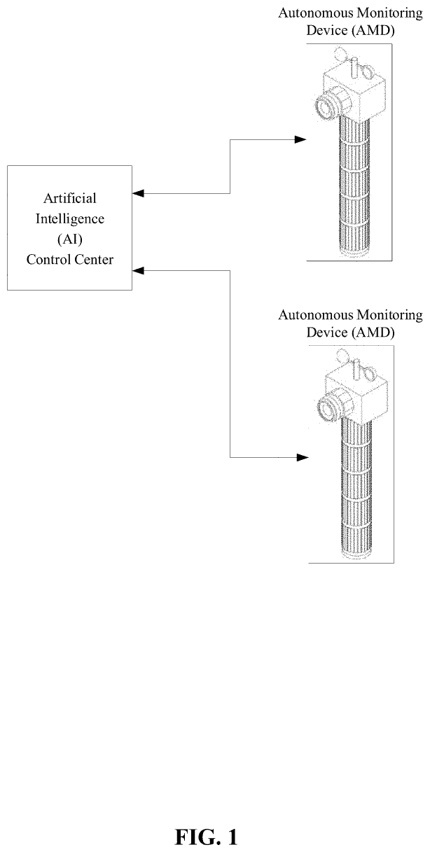

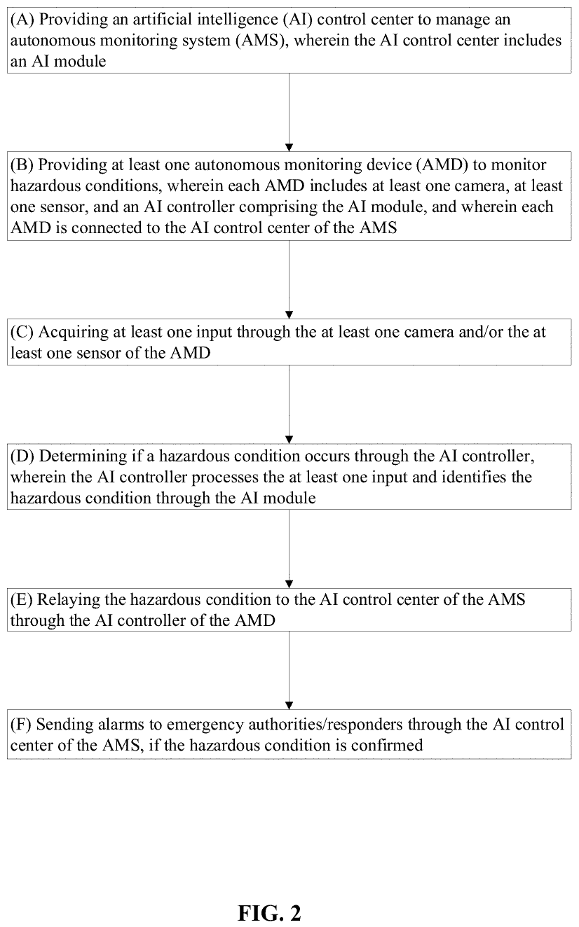

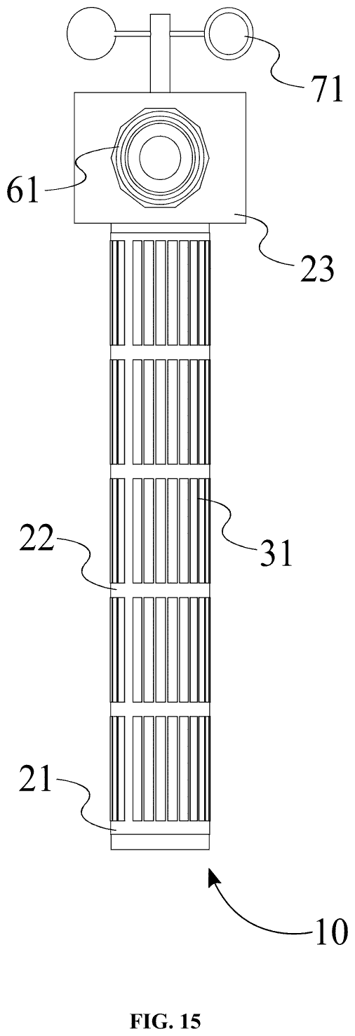

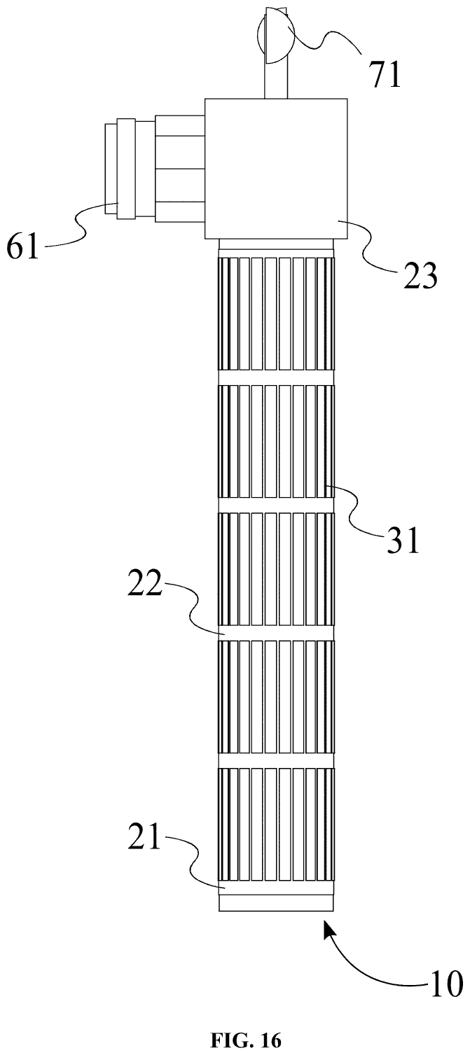

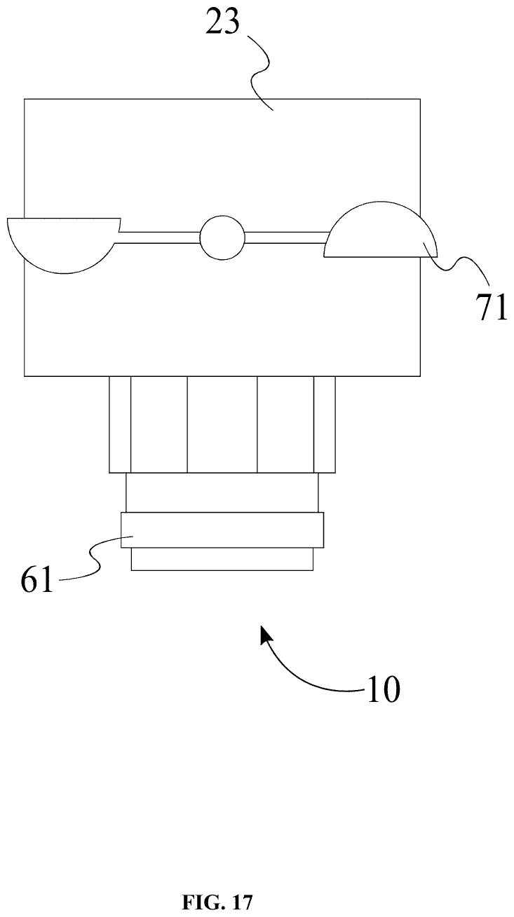

As can be seen in FIG. 1 to FIG. 18, the method of the present invention facilitates the autonomous monitoring of hazardous conditions. The overall process of the method, as can be seen in FIG. 2, starts by providing an AI control center to manage an AMS, wherein the AI control center includes an AI module (Step A). Additionally, the method provides at least one AMD to monitor hazardous conditions, wherein each AMD includes at least one camera, at least one sensor, and an AI controller comprising the AI module, and wherein each AMD is connected to the AI control center of the AMS (Step B), as can be seen in FIG. 1. Subsequently, the method acquires at least one input through the at least one camera and/or the at least one sensor of the AMD (Step C). Then, the method determines if a hazardous condition occurs through the AI controller, wherein the AI controller processes the at least one input and identifies the hazardous condition through the AI module (Step D). Next, the method relays the hazardous condition to the AI control center of the AMS through the AI controller of the AMD (Step E). Further, the method sends alarms to emergency authorities/responders through the AI control center of the AMS, if the hazardous condition is confirmed (Step F).

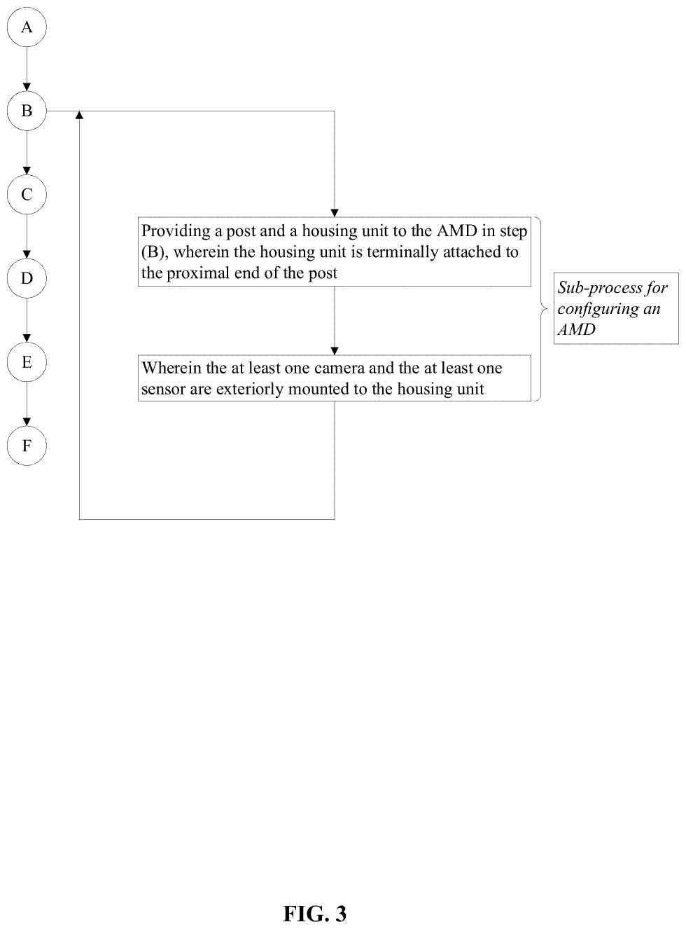

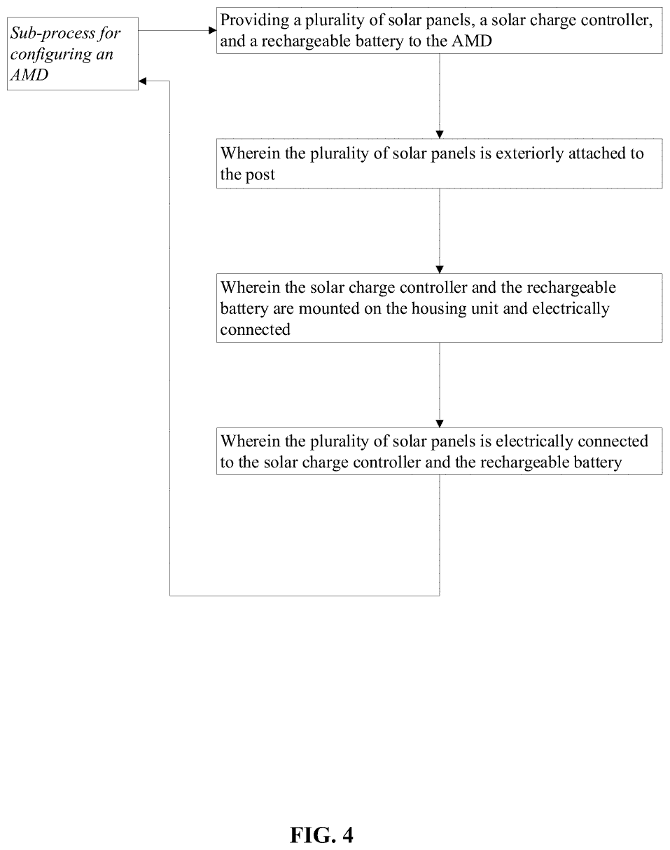

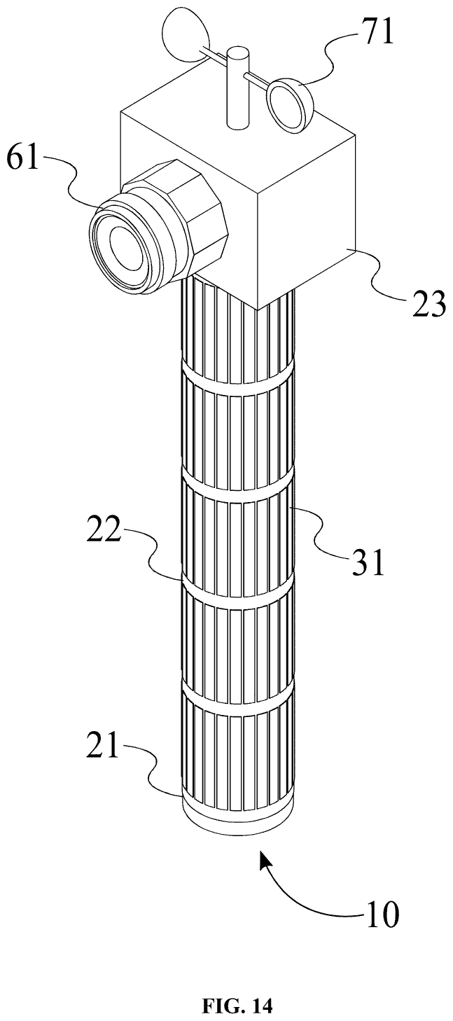

As can be seen in FIG. 3, and FIG. 14 to FIG. 18, the method of the present invention provides a sub-process for configuring the AMD 10. The method provides a post 21 and a housing unit 23 to the AMD 10 in Step B, wherein the housing unit 23 is terminally attached to the proximal end of the post 21; and wherein the at least one camera 61 and the at least one sensor 71 are exteriorly mounted to the housing unit 23. Additionally, the post 21 comprises a pole 22, which is the body of the post that supports the housing unit 23. As can be seen in FIG. 4, and FIG. 14 to FIG. 18, the sub-process for configuring the AMD 10 provides a plurality of solar panels 31, a solar charge controller 41, and a rechargeable battery 51 to the AMD 10; wherein the plurality of solar panels 31 is exteriorly attached to the post 21. Additionally, the solar charge controller 41 and the rechargeable battery 51 are mounted on the housing unit 23 and electrically connected. Further, the plurality of solar panels 31 is electrically connected to the solar charge controller 41 and the rechargeable battery 51.

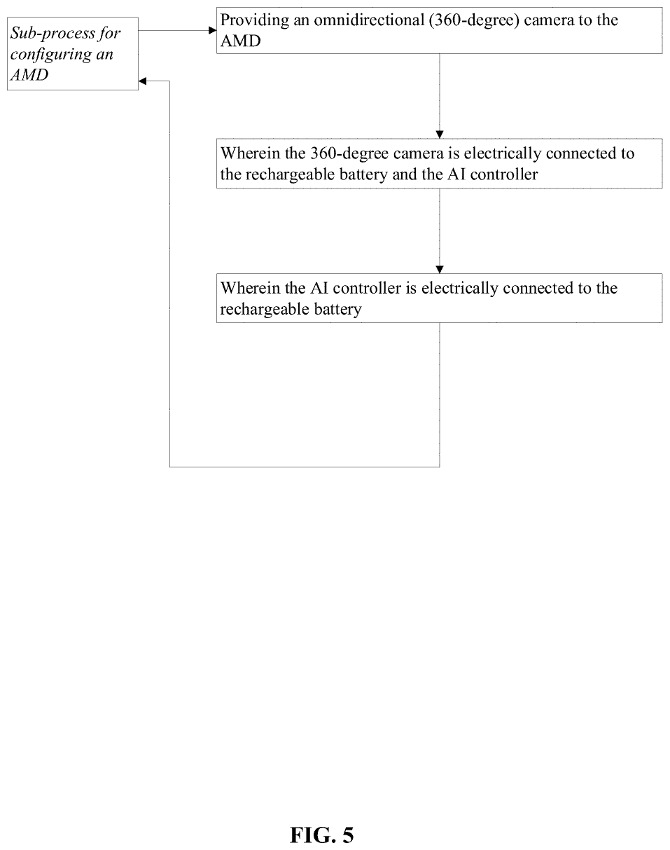

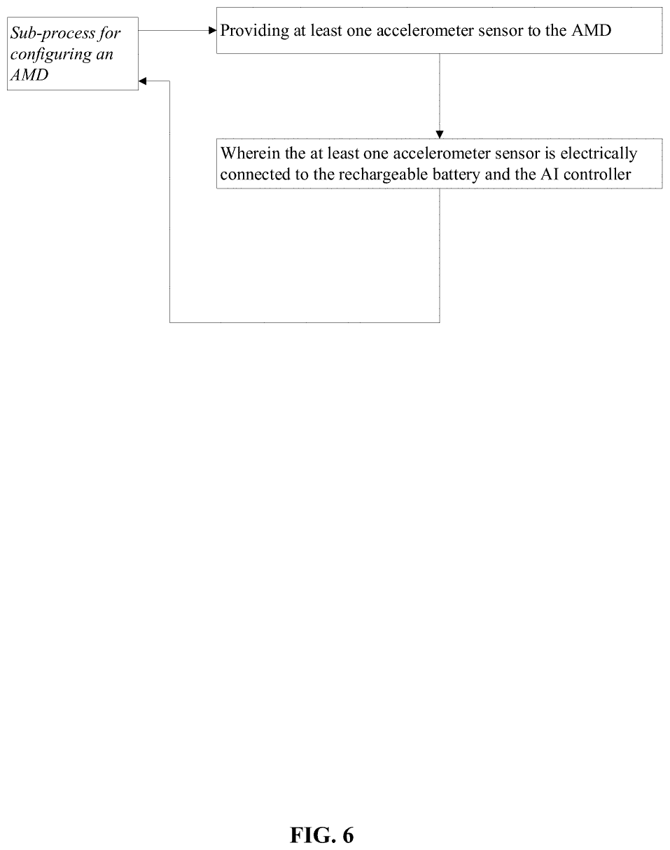

As can be seen in FIG. 5, and FIG. 14 to FIG. 18, the sub-process for configuring the AMD 10 provides an omnidirectional (360-degree) camera 61 to the AMD 10; wherein the 360-degree camera 61 is electrically connected to the rechargeable battery 51 and the AI controller 81; and wherein the AI controller 81 is electrically connected to the rechargeable battery 51. As can be seen in FIG. 6, and FIG. 14 to FIG. 18, the sub-process provides at least one accelerometer sensor 71 to the AMD 10 and the at least one accelerometer sensor 71 is electrically connected to the rechargeable battery 51 and the AI controller 81. Additionally, the sub-process provides at least one sensor 71 selected from a group comprising a wind sensor, a lidar sensor, a barometer, an accelerometer, a light sensor, a temperature sensor, a humidity sensor, or a gas sensor to the AMD 10 and the sensor 71 is electrically connected to the rechargeable battery 51 and the AI controller 81.

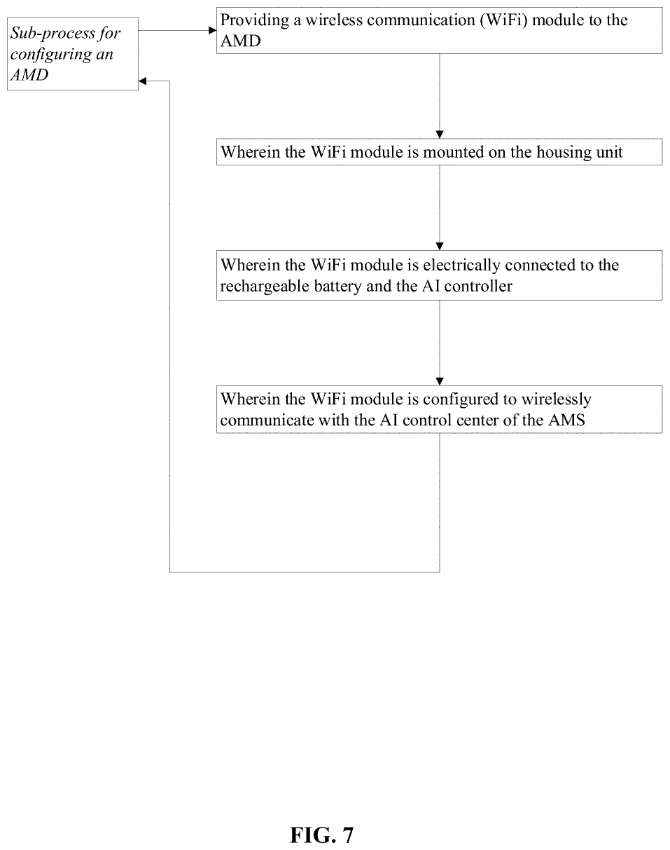

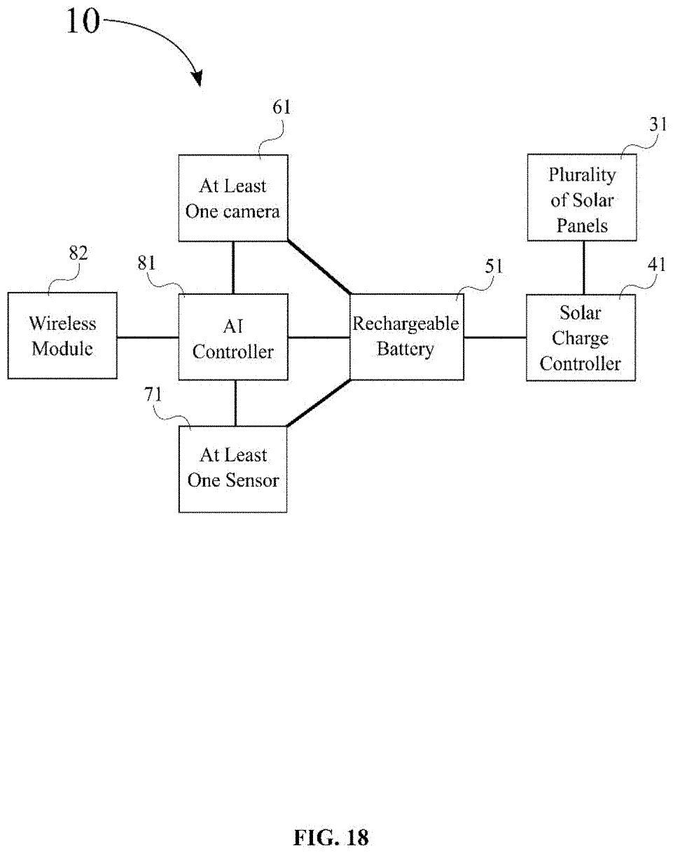

As can be seen in FIG. 7 and FIG. 18, the sub-process for configuring the AMD 10 provides a wireless communication (WiFi) module 82 to the AMD 10. Specifically, the WiFi module 82 is mounted on the housing unit 23. The WiFi module 82 is electrically connected to the rechargeable battery 51 and the AI controller 81 and is configured to wirelessly communicate with the AI control center of the AMS. Further, the WiFi module 82 may facilitates wireless communications through a network including, but is not limited to, Internet, cellular network, or satellite network, etc.

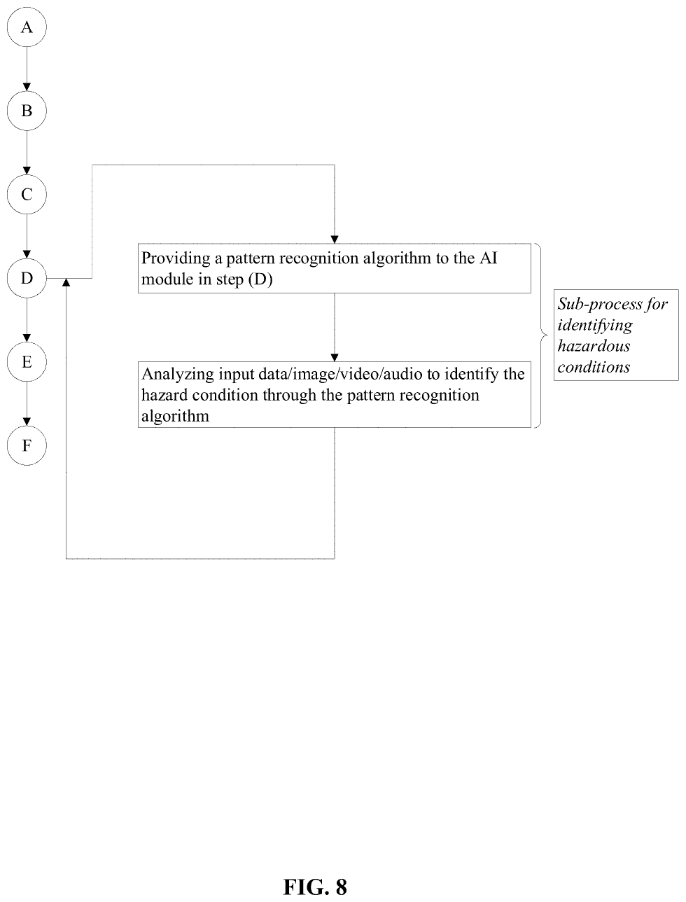

As can be seen in FIG. 8, the method of the present invention provides a sub-process for identifying hazardous conditions through the AMD 10. The method provides a pattern recognition algorithm to the AI module in Step D. Subsequently, the method analyzes input data/image/video/audio to identify the hazard condition through the pattern recognition algorithm. The pattern recognition algorithm takes any input from the at least one camera 61 and the at least one sensor 71 in any format including, but not limited to, quantitative data and/or measurements, images, videos, audios, or any combination thereof. The algorithm then uses the pattern recognition AI technology to determine if and what a hazardous condition occurs.

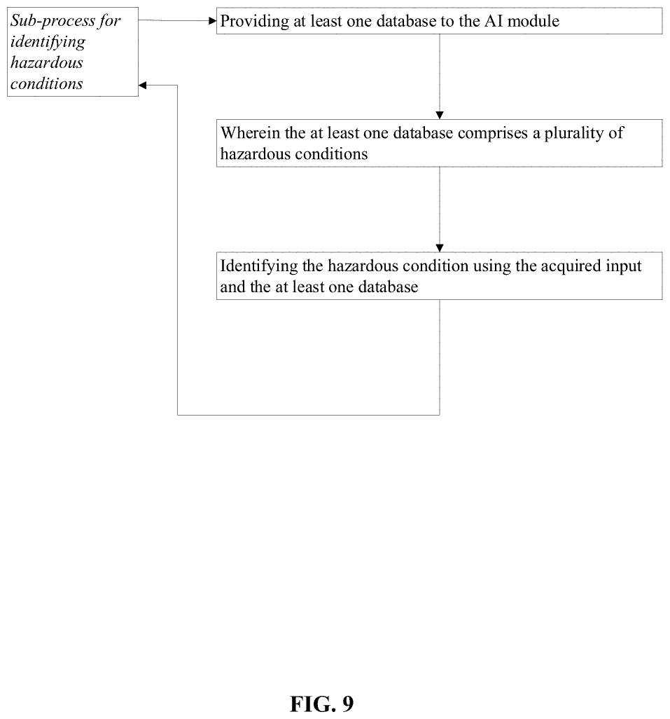

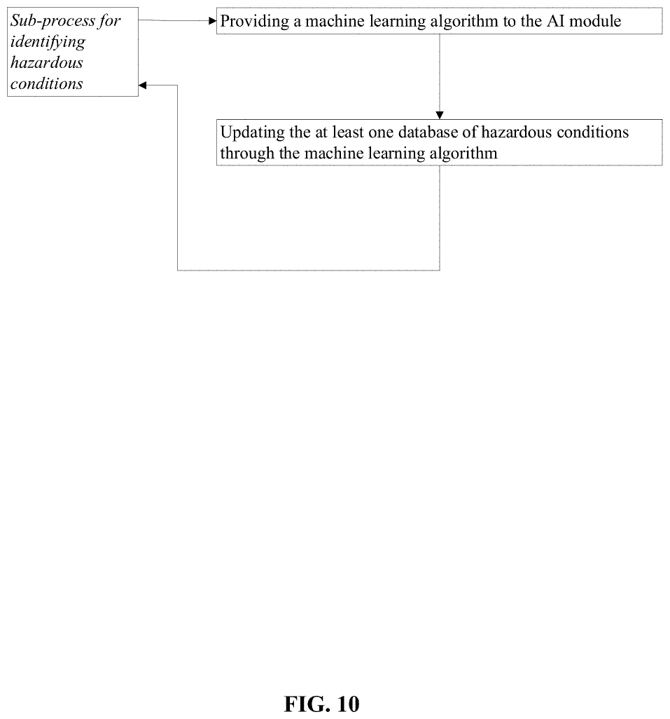

As can be seen in FIG. 9, the sub-process for identifying hazardous conditions through the AMD 10 provides at least one database to the AI module. Specifically, the at least one database comprises a plurality of hazardous conditions. Subsequently, the method identifies the hazardous condition using the acquired input and the at least one database. As can be seen in FIG. 10, in an alternative embodiment, the method provides a machine learning algorithm to the AI module, and updates the at least one database of hazardous conditions through the machine learning algorithm.

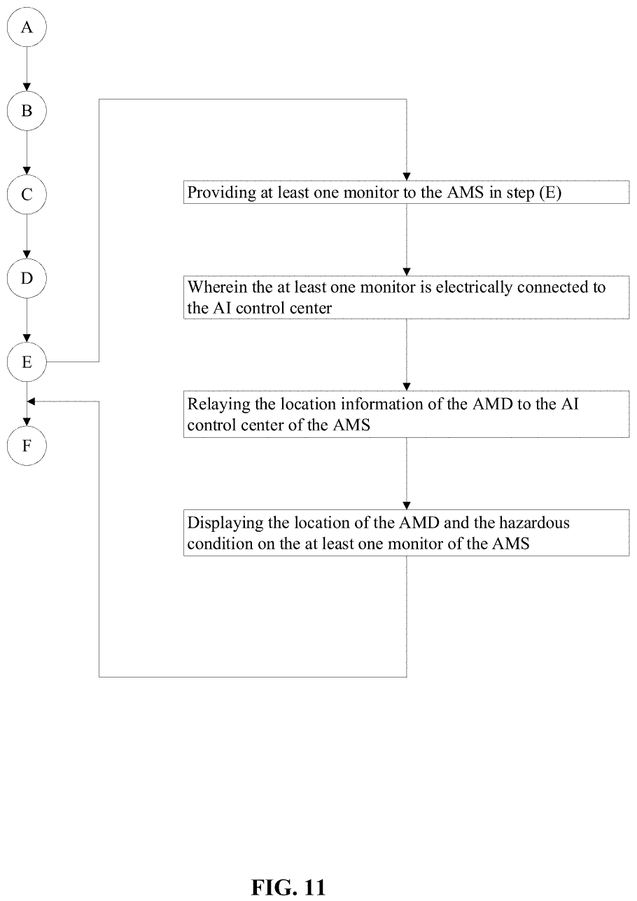

As can be seen in FIG. 11, the method of the present invention provides at least one monitor to the AMS in Step E; wherein the at least one monitor is electrically connected to the AI control center. Specifically, the method relays the location information of the AMD 10 to the AI control center of the AMS and displays the location of the AMD and the hazardous condition on the at least one monitor of the AMS. The monitor includes, but is not limited to, a computer monitor, an LED (light-emitting diode) display, a TV (television) set, a map, a list, a table, or any combination thereof. In an alternative embodiment of the present invention, the method provides at least one map to the AI control center of the AMS. Specifically, the map is used to visually and geographically show all AMDs that have detected hazardous conditions. Additionally, the at least one monitor is displayed on the at least one monitor, and the map displays the location of the AMD on the map.

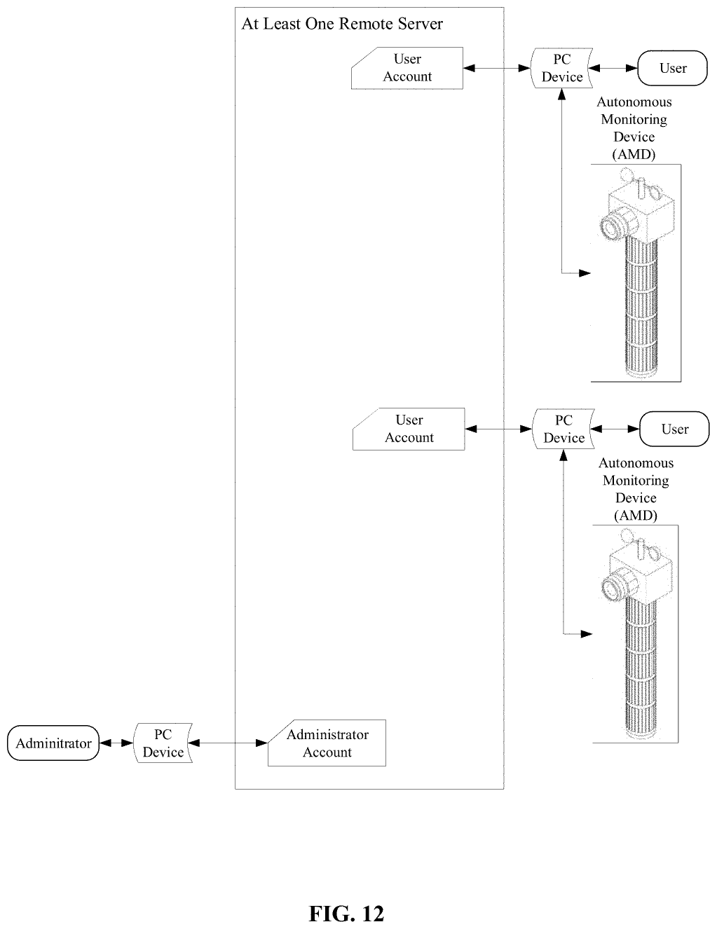

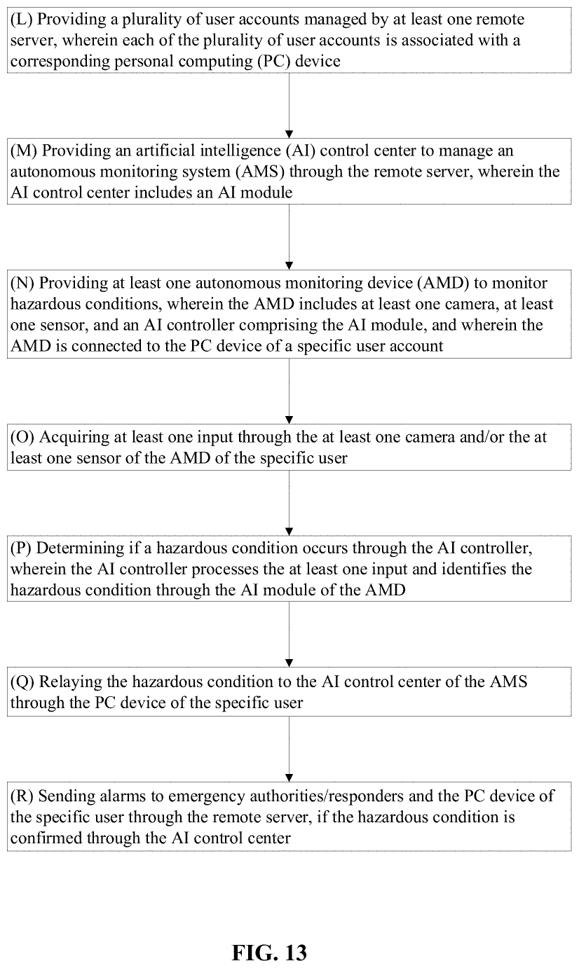

As can be seen in FIG. 12 to FIG. 13, the present invention further provides an online platform and/or a mobile app for autonomously and continuously monitoring hazardous conditions to a user. To accomplish this, the method of the present invention associates each of the plurality of users with a unique user account from a plurality of user accounts that are managed by at least one remote server (Step L), as seen in FIG. 13. Each of the plurality of user accounts is associated with a corresponding personal computing (PC) device. The corresponding PC device allows a user to interact with the present invention and can be, but is not limited to, a smartphone, a smart watch, a cloud PC, a laptop, a desktop PC, a server, a terminal PC, or a tablet PC, etc. The users of the user accounts may include relevant parties such as, but are not limited to, individuals, home owners, building managers, office managers, managers, business owners, consumers, companies, corporations, hospitals, government entities, offices, emergency responders, police department, fire department, law enforcement, administrators, etc. Further, the at least one remote server is used to manage the medical treatment analysis platform for the plurality of user accounts. The remote server can be managed through an administrator account by an administrator as seen in FIG. 12. The administrator who manages the remote server includes, but is not limited to, owner, service provider, manager, technician, engineer, system engineer, system specialist, software engineer, information technology (IT) engineer, IT professional, IT manager, IT consultant, service desk professional, service desk manager, consultant, manager, executive officer, chief operating officer, chief technology officer, chief executive officer, president, company, corporation, organization, etc. Moreover, the remote server is used to execute a number of internal software processes and store data for the present invention. The software processes may include, but are not limited to, server software programs, web-based software applications or browsers embodied as, for example, but not limited to, websites, web applications, desktop applications, cloud applications, and mobile applications compatible with a corresponding user PC device. Additionally, the software processes may store data into internal databases and communicate with external databases, which may include but are not limited to hazardous condition databases, emergency personnel databases, housing databases, building databases, geographical databases, sensor databases, databases maintaining data about natural disasters, databases maintaining emergency correspondence, etc. The interaction with external databases over a communication network may include, but is not limited to, the Internet.

As can be seen in FIG. 13, the overall process of the method of the present invention provides an artificial intelligence (AI) control center to manage an autonomous monitoring system (AMS) through the remote server, wherein the AI control center includes an AI module (Step M). Subsequently, the method provides at least one autonomous monitoring device (AMD) to monitor hazardous conditions, wherein the AMD includes at least one camera, at least one sensor, and an AI controller comprising the AI module, and wherein the AMD is connected to the PC device of a specific user account (Step N). Further, the method acquires at least one input through the at least one camera and/or the at least one sensor of the AMD of the specific user (Step 0). Subsequently, the method determines if a hazardous condition occurs through the AI controller, wherein the AI controller processes the at least one input and identifies the hazardous condition through the AI module of the AMD (Step P). Once a hazardous condition is determined, the method prepares an analysis of the specific medical treatment, which is the actual treatment rendered by the user. Often, there is a discrete seminal event that discriminates the specific treatment from the hypothetical treatment; other times there is not. For example, in the case of intestinal obstruction following abdominal surgery, scar tissue may adhere bowel together resulting in some modification of standard technique. Actual treatment that is different from the hypothetical treatment does not necessarily imply that there is a breach of duty to perform within the standards of care. Judgment should be reserved over these differences until the results are tested by the present invention relays the hazardous condition to the AI control center of the AMS through the PC device of the specific user (Step Q), and sends alarms to emergency authorities/responders and the PC device of the specific user through the remote server, if the hazardous condition is confirmed through the AI control center (Step R).

Although the invention has been explained in relation to its preferred embodiment, it is to be understood that many other possible modifications and variations can be made without departing from the spirit and scope of the invention, such as: Home Security, Earthquake Monitoring, Area Observation. etc.

Although the invention has been explained in relation to its preferred embodiment, it is to be understood that many other possible modifications and variations can be made without departing from the spirit and scope of the invention as hereinafter claimed.

What is claimed is:

1. A method for monitoring hazardous conditions, the method comprising the steps of:
(A) providing an artificial intelligence (AI) control center to manage an autonomous monitoring system (AMS), wherein the AI control center includes an AI module;
(B) providing at least one autonomous monitoring device (AMD) to monitor hazardous conditions, wherein each AMD includes at least one camera, at least one sensor, and an AI controller comprising the AI module, and wherein each AMD is connected to the AI control center of the AMS;
(C) acquiring at least one input through the at least one camera and/or the at least one sensor of the AMD;
(D) determining if a hazardous condition occurs through the AI controller, wherein the AI controller processes the at least one input and identifies the hazardous condition through the AI module;
(E) relaying the hazardous condition to the AI control center of the AMS through the AI controller of the AMD; and
(F) sending alarms to emergency authorities/responders through the AI control center of the AMS, if the hazardous condition is confirmed.

2. The method for monitoring hazardous conditions as claimed in claim 1, the method comprising the steps of:
providing a post and a housing unit to the AMD in step (B), wherein the housing unit is terminally attached to the proximal end of the post; and
wherein the at least one camera and the at least one sensor are exteriorly mounted to the housing unit.

3. The method for monitoring hazardous conditions as claimed in claim 2, the method comprising the steps of:
providing a plurality of solar panels, a solar charge controller, and a rechargeable battery to the AMD;
wherein the plurality of solar panels is exteriorly attached to the post;
wherein the solar charge controller and the rechargeable battery are mounted on the housing unit and electrically connected; and
wherein the plurality of solar panels is electrically connected to the solar charge controller and the rechargeable battery.

4. The method for monitoring hazardous conditions as claimed in claim 3, the method comprising the steps of:
providing an omnidirectional (360-degree) camera to the AMD;
wherein the 360-degree camera is electrically connected to the rechargeable battery and the AI controller; and
wherein the AI controller is electrically connected to the rechargeable battery.

5. The method for monitoring hazardous conditions as claimed in claim 3, the method comprising the steps of:
providing at least one accelerometer sensor to the AMD; and
wherein the at least one accelerometer sensor is electrically connected to the rechargeable battery and the AI controller.

6. The method for monitoring hazardous conditions as claimed in claim 3, the method comprising the steps of:
providing at least one sensor selected from a group comprising a wind sensor, a lidar sensor, a barometer, an accelerometer, a light sensor, a temperature sensor, a humidity sensor, or a gas sensor to the AMD; and
wherein the sensor is electrically connected to the rechargeable battery and the AI controller.

7. The method for monitoring hazardous conditions as claimed in claim 3, the method comprising the steps of:
providing a wireless communication (WiFi) module to the AMD;
wherein the WiFi module is mounted on the housing unit;
wherein the WiFi module is electrically connected to the rechargeable battery and the AI controller; and
wherein the WiFi module is configured to wirelessly communicate with the AI control center of the AMS.

8. The method for monitoring hazardous conditions as claimed in claim 1, the method comprising the steps of:
providing a pattern recognition algorithm to the AI module in step (D); and
analyzing input data/image/video/audio to identify the hazard condition through the pattern recognition algorithm.

9. The method for monitoring hazardous conditions as claimed in claim 8, the method comprising the steps of:
providing at least one database to the AI module;
wherein the at least one database comprises a plurality of hazardous conditions; and
identifying the hazardous condition using the acquired input and the at least one database.

10. The method for monitoring hazardous conditions as claimed in claim 8, the method comprising the steps of:
providing a machine learning algorithm to the AI module; and
updating the at least one database of hazardous conditions through the machine learning algorithm.

11. The method for monitoring hazardous conditions as claimed in claim 1, the method comprising the steps of:
providing at least one monitor to the AMS in step (E);
wherein the at least one monitor is electrically connected to the AI control center;
relaying the location information of the AMD to the AI control center of the AMS; and
displaying the location of the AMD and the hazardous condition on the at least one monitor of the AMS.

12. The method for monitoring hazardous conditions as claimed in claim 11, the method comprising the steps of:
providing at least one map to the AI control center of the AMS;
wherein the at least one monitor is displayed on the at least one monitor; and
displaying the location of the AMD on the map.

13. A method for monitoring hazardous conditions, the method comprising the steps of:
(L) providing a plurality of user accounts managed by at least one remote server, wherein each of the plurality of user accounts is associated with a corresponding personal computing (PC) device;
(M) providing an artificial intelligence (AI) control center to manage an autonomous monitoring system (AMS) through the remote server, wherein the AI control center includes an AI module;
(N) providing at least one autonomous monitoring device (AMD) to monitor hazardous conditions, wherein the AMD includes at least one camera, at least one sensor, and an AI controller comprising the AI module, and wherein the AMD is connected to the PC device of a specific user account;
(O) acquiring at least one input through the at least one camera and/or the at least one sensor of the AMD of the specific user;
(P) determining if a hazardous condition occurs through the AI controller, wherein the AI controller processes the at least one input and identifies the hazardous condition through the AI module of the AMD;
(Q) relaying the hazardous condition to the AI control center of the AMS through the PC device of the specific user; and
(R) sending alarms to emergency authorities/responders and the PC device of the specific user through the remote server, if the hazardous condition is confirmed through the AI control center.
